(19) United States
(12) Patent Application Publication
(10) Pub. No.: US 2025/0320370 A1
(43) Pub. Date: Oct. 16, 2025

(54) METHODS OF FORMING BIODEGRADABLE POLYMERIC FILMS AND THE BIODEGRADABLE POLYMERIC FILMS FORMED THROUGH THE METHODS

(71) Applicant: HONEYWELL INTERNATIONAL INC., Charlotte, NC (US)

(72) Inventors: Srinivas Cherukupalli, Hyderabad (IN); Samit Chaudhari, Mumbai (IN)

(73) Assignee: HONEYWELL INTERNATIONAL INC., Charlotte, NC (US)

(21) Appl. No.: 19/071,932

(22) Filed: Mar. 6, 2025

Related U.S. Application Data
(60) Provisional application No. 63/632,369, filed on Apr. 10, 2024.

(51) Int. Cl. C09D 103/02; C09D 7/61

(52) U.S. Cl. CPC C09D 103/02; C09D 7/61

(57) ABSTRACT

Methods of forming biodegradable polymeric films, biodegradable polymeric films produced through the methods, and composite articles comprising the biodegradable polymeric films are provided herein. In an embodiment, the methods include the steps of mixing a heterogeneous additive and a plasticizer to form a slurry, mixing the slurry and a biodegradable polymer to form a dough, and gel extruding the dough to form an extrudate. In an embodiment, a biodegradable polymeric film is formed by a method comprising the recited steps. In an embodiment, a composite article comprises the biodegradable polymeric film and an additional layer having a composition different from that of the biodegradable polymeric film.

### CROSS REFERENCE TO RELATED APPLICATION

This application claims the benefit of U.S. Provisional Application No. 63/632,369, filed Apr. 10, 2024.

### TECHNICAL FIELD

The present disclosure generally relates to methods of forming polymeric films and films formed through the methods, and more particularly relates to methods of forming biodegradable polymeric films and films formed through the methods.

### BACKGROUND

Polymeric films are generally composed of a polymer within which additives and other materials are dispersed. Polymeric films are used in a variety of applications including packaging, labels, coatings, and construction materials. For example, many packaging materials are made from polymeric films due to the flexibility and durability of these films. Objectives accomplished by packaging include preventing damage to products and maintaining desirable properties and appearance of products. Applications for polymeric film packaging materials include bubble wrap, blister packages for pharmaceuticals, films or bags for storing food products, and bottles for containing liquid products.

Another application for polymeric packaging materials relates to packaging of metal products. Ferrous and non-ferrous metal products are susceptible to environmental physical, chemical, or electrochemical deterioration when the metal products come in contact with moisture and oxygen. One example of such deterioration is corrosion. Indications of corrosion may include oxidation, pitting, tarnishing, or discoloration of a surface of the metal products. Barrier coatings such as paint, plastic, peelable coatings, rust preventative oils, cathodic protection, or dip galvanization can minimize corrosion of the surfaces of the metal products. However, for many articles, such coatings are undesirable.

To avoid the need for barrier coatings, one solution known in the industry uses polymeric packaging materials with additives or coatings containing volatile corrosion inhibitors (VCIs). VCIs are materials that can decrease the corrosion rate of metal. VCIs work by vaporizing into the atmosphere of an enclosed environment. The vapors distribute throughout the environment until equilibrium is reached. Then, the vapor will begin condensing onto the surface of the metal object, creating a protective layer on the surface. Examples of VCIs include nitrites of amines, amine carboxylates, heterocyclic compounds, carboxylic acid esters, or acetylenic alcohols.

One process for creating a polymeric film involves addition of fillers and other additives, usually as a masterbatch, to a polymer matrix, during a hot melt extrusion process. For example, in a process to create VCI packaging, suitable VCIs and other additives are added to polymer-based film carriers, and the mixture is extruded in a hot melt process to form a VCI film. Alternatively, VCI compositions may be applied to the film after the film is formed.

Many polymeric films end up in landfills and break down into microplastics. Due to health, safety, and environmental concerns, there is an increasing demand for materials which are biodegradable. A biodegradable material creates biomass rather than microplastics when it breaks down. Some biodegradable polymeric films are currently in use. Such films are generally manufactured through a masterbatch process, in which biodegradable polymers are blended with a masterbatch of solid additives. The resulting biodegradable granules are then formed into a biodegradable polymer film.

Existing biodegradable polymeric films have several shortcomings. Because biodegradable polymers are sensitive to heat and other extreme process conditions, the biodegradable polymers may degrade during conventional processes of forming polymeric films such as hot melt extruding. As a result, the films do not have desirable physical properties and may fall apart when exposed to water or when physically handled, and often the films are not durable enough to be reused. Further, existing biodegradable polymeric films tend to have a high water vapor transmission rate (WVTR), meaning that water vapor can travel through the packaging. Permeability of existing biodegradable polymeric films may also let oxygen and other substances pass through the film. Intrusion of water vapor or oxygen through a film used for packaging may cause damage to the packaged product. These problems carry over to biodegradable packaging materials made up of the biodegradable polymeric films, including biodegradable VCI packaging. Further, VCI packaging made from biodegradable polymeric films exhibits lower VCI activity than VCI packaging made from other materials.

Accordingly, it is desirable to provide methods of producing a biodegradable polymeric film which minimize degradation of the biodegradable polymer and result in a film having excellent physical properties, including stretchability and malleability, for use in a variety of applications. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Methods of forming biodegradable polymeric films, biodegradable polymeric films produced through the methods, and composite articles comprising the biodegradable polymeric films are provided herein. In an embodiment, a method includes mixing a heterogeneous additive with a plasticizer to form a slurry, mixing the slurry and a biodegradable polymer to form a dough, and gel extruding the dough to form an extrudate. In an embodiment, a biodegradable polymeric film is formed by a method comprising the recited steps. In an embodiment, a composite article includes a layer comprising the biodegradable polymeric film and an additional layer having a composition different from that of the biodegradable polymeric film.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Biodegradable polymeric films and methods of forming the films are provided herein that enable excellent properties to be achieved as a result of maximized dispersion of heterogeneous additives throughout the film. Furthermore, the methods as contemplated herein enable maximized dispersion of heterogeneous additives in the absence of extreme process conditions, such as high temperatures, that are ordinarily attendant with melt extrusion processes. It has been found that the more uniform the dispersion of the heterogeneous additives in the film, the better the polymeric film performs, particularly with stretchability and malleability. Unlike hot melt extrusion processes, gel extrusion processes do not require extreme process conditions such as high heat, thus avoiding excessive breakdown of the biodegradable polymer.

Despite the benefits of gel extrusion processes, dispersing additives throughout the polymeric film may be challenging during a gel extrusion process because the polymer is not melted into a liquid form. It has been found that mixing the biodegradable polymer and a slurry comprising the heterogeneous additive and a plasticizer prior to the gel extrusion leads to improved dispersion of the heterogeneous additive in the biodegradable polymeric film, as compared to adding the heterogeneous additive in masterbatch form during the extrusion process. Further, the plasticizer functions to increase melt flow index of the biodegradable polymer to facilitate gel extrusion.

The combination of gel extrusion, and mixing the biodegradable polymer with a slurry comprising the heterogeneous additive and the plasticizer prior to the extrusion, leads to biodegradable polymeric films that have maximized performance parameters, including increased strength, increased stretchability, and increased malleability, as compared to existing biodegradable polymeric films. Improved dispersion of the heterogeneous additives in the film allows for a maximized loading of the heterogeneous additive in combination with maximized physical properties of the film. In some applications, if VCI additives are present in the biodegradable polymeric films, increased VCI activity is achieved as a result of improved dispersion of the additives in the film. In one particular application for packaging metal parts in VCI packaging, the disclosed biodegradable polymeric films are capable of protecting packaged metal parts from corrosion despite possibly having a higher water vapor transmission rate (WVTR) than existing VCI films. Further, composite articles incorporating the biodegradable polymeric films provided herein exhibit excellent properties, including but not limited to VCI activity, flexibility, moldability, and reusability.

Unless specifically stated or obvious from context, as used herein, the term “about” is understood as within a range of normal tolerance in the art measured using standard measurement devices, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The biodegradable polymeric films provided herein comprise a biodegradable polymer, a heterogeneous additive, and a plasticizer. The biodegradable polymeric films are formed through a process comprising the steps of mixing the heterogeneous additive and the plasticizer to form a slurry, mixing the slurry and the biodegradable polymer to form a dough, and gel extruding the dough to form an extrudate. It has been found that the recited process steps result in a maximized uniformity of dispersion of the heterogeneous additive throughout the polymeric film and minimized degradation of the biodegradable polymer, which leads to excellent properties of the film, including strength, malleability, and stretchability.

The methods provided herein include the step of mixing the heterogeneous additive and the plasticizer to form the slurry. The slurry may contain only one heterogeneous additive, or alternatively the slurry may contain more than one heterogeneous additive. As used herein, “heterogeneous additive” refers to a filler in particulate form that exhibits variable concentration throughout a bulk of the film. As used herein, “filler in particulate form” indicates that the material is made up of minute separate particles, and that the material has no dynamic viscosity (i.e. is not flowable) at all processing temperatures experienced during the methods described herein. A heterogeneous additive may have a variety of properties and uses. Examples of heterogeneous additives include fillers such as fumed silica, precipitated silica, titanium dioxide, talc, calcium carbonate, zinc oxide, graphene, activated carbon, diatomaceous earth, glass fibers, clay, and/or combinations thereof. Alternatively, the heterogeneous additive may be an antioxidant.

In embodiments, the heterogeneous additive may comprise a volatile corrosion inhibitor (VCI) additive. As used herein, a “VCI additive” refers to a chemical compound that acts to reduce corrosion of metals though volatilization, vapor transport in the atmosphere of an enclosed environment, and condensation onto a metal surface. Use of a VCI additive, in combination with the uniformity of dispersion exhibited by the biodegradable polymeric films provided herein, results in polymeric films having higher VCI activity than existing polymeric films which contain VCI additives but do not achieve excellent dispersion of the VCI additives. A polymeric film having maximized VCI activity provides excellent corrosion resistance to metal objects packaged inside the film.

In embodiments, the bulk density of the heterogeneous additive may be less than about 300 kg/m³, alternatively from about 160 kg/m³ to about 300 kg/m³, alternatively less than about 200 kg/m³, alternatively from about 160 kg/m³ to about 190 kg/m³. Generally, heterogeneous additives with relatively low bulk densities are difficult to mix evenly with a polymer, resulting in a poor dispersion of the heterogeneous additives in the polymeric film. However, the methods as contemplated herein enable use of heterogeneous additives with the recited bulk densities in combination with the uniformity of dispersion and physical properties exhibited by the biodegradable polymeric films provided herein to be achievable.

In embodiments, at least 50% of the particles of the heterogeneous additive have an aspect ratio of from about 1 to about 300, alternatively from about 1 to about 50, alternatively at least about 25, alternatively at least about 50, alternatively from about 50 to about 100, alternatively at least about 100, alternatively from about 100 to about 300. Generally, heterogeneous additives with particles having relatively high aspect ratios are difficult to mix evenly with a polymer, resulting in a poor dispersion of the heterogeneous additives in the polymeric film. However, the methods as contemplated herein enable use of heterogeneous additives with the recited ranges of aspect ratios in combination with the uniformity of dispersion and physical properties exhibited by the biodegradable films provided herein to be achievable.

In embodiments, the loading of the heterogeneous additive may be from about 0.1 wt % to about 70 wt %, alternatively at least about 10 wt %, alternatively from about 10 wt % to about 60 wt %, alternatively at least about 20 wt %, alternatively from about 20 wt % to about 70 wt %, alternatively from about 20 wt % to about 40 wt %, alternatively from about 20 wt % to about 30 wt %, based on a total weight of the polymer film. Importantly, the recited loading levels can be achieved due to the improved dispersion of heterogeneous additive, while still maintaining maximized physical properties including stretchability and malleability.

In addition to the heterogeneous additive, the slurry contains the plasticizer. As used herein, “plasticizer” refers to a substance that promotes plasticity and flexibility of a polymer, but is not a polymer itself. The plasticizer is in liquid form at least at one temperature reached during the process. The plasticizer is in continuous form (i.e. not in particulate form). The slurry may contain only one plasticizer, or alternatively, the slurry may contain more than one plasticizer. For example, the plasticizer may be a mono alcohol such as polyethylene glycol, a diol such as propylene glycol, a triol such as glycerol, sorbitol, natural oils, and/or combinations thereof.

In embodiments, the plasticizer may exhibit antioxidant properties at typical environmental temperatures of from-20° C. to 70° C. For example, the plasticizer may be a diol such as propylene glycol, a triol such as glycerol, and/or combinations thereof. Use of a plasticizer which exhibits antioxidant properties eliminates the need for an additional additive exhibiting antioxidant properties in embodiments in which the final application of the biodegradable polymeric film requires the film to exhibit antioxidant properties. In one particular embodiment, the heterogeneous additive is a VCI additive, and the plasticizer exhibits antioxidant properties. When both an antioxidant and a VCI additive are present, the antioxidant improves the VCI activity of the VCI additive. When the biodegradable polymeric film of this embodiment is used to package a ferrous or non-ferrous metal object, the plasticizer having antioxidant properties may form a complex with the metal, which may act as a barrier to inhibit corrosion of metals. The barrier, in combination with the activity of the VCI additive, achieves excellent corrosion resistance.

The process step of mixing the heterogeneous additive and the plasticizer to form the slurry ensures that the heterogeneous additive and plasticizer are dispersed evenly throughout the slurry. This in turn facilitates even distribution of the heterogeneous additive and plasticizer throughout the dough and the extrudate during the downstream process steps, as described below. The presence of the plasticizer in the slurry affects the flow properties of the resulting dough, the benefits of which are described below.

In embodiments, the slurry is formed by mixing the heterogeneous additive and the plasticizer in a high shear mixer. A high shear mixer can disperse one phase into another phase with which miscibility may otherwise be poor. Thus, the heterogeneous additive and the plasticizer in the slurry may be two phases that would exhibit poor miscibility under non-shear mixing conditions. A high shear mixer includes an impeller (a moving component) and a stator (a stationary component) within a tank or pipe. The impeller and stator create shear forces which contribute to mixing. An example of a high shear mixer is a 10 Liter Littleford W-10 High Intensity Mixer.

High shear mixing the heterogeneous additive and the plasticizer to form the slurry achieves excellent mixing of the heterogeneous additive and the plasticizer, even if the heterogeneous additive and the plasticizer do not mix easily under standard mixing conditions. The resulting slurry of the heterogeneous additive and the plasticizer also allows the liquid plasticizer to carry the heterogeneous additive throughout the polymer when the slurry is mixed with the polymer, as described below.

The methods provided herein further include a step of mixing the slurry and the biodegradable polymer to form the dough. As used herein, “dough” refers to a mixture containing the biodegradable polymer, the heterogeneous additive, and the plasticizer, and having specified flow properties. The dough is capable of being formed into different shapes and maintaining its shape at a temperature of 100° C. and atmospheric pressure. The dough is also flowable under the conditions of a gel extrusion process, as described below. Specifically, the dough has a melt flow index (MFI) of at least about 5 (+/−2) g/10 min, alternatively from about 5 (+/−2) g/10 min to about 12 (+/−2) g/10 min, alternatively at least 12 (+/−2) g/10 min, as measured at a dough temperature of 190° C. with a load of 2.16 kg.

As used herein, “biodegradable polymer” refers to a polymeric material which is capable of undergoing decomposition into carbon dioxide, methane, water, inorganic compounds, or biomass, through the enzymatic action of microorganisms, under any conditions and over any period of time. A biodegradable polymer may or may not be “compostable” as defined by the compostability test method of ASTM standard D6400. A biodegradable polymer may or may not be recyclable.

In embodiments, the biodegradable polymer is a compostable polymer. As used herein, “compostable polymer” refers to a polymeric material which is capable of undergoing decomposition into carbon dioxide, methane, water, inorganic compounds, or biomass, through the enzymatic action of microorganisms, over a minimum of 90 days in an aerobic and controlled composting environment. The conditions required for the aerobic and controlled composting environment are described in the US industrial composting standards ASTM D6400 and ASTM D6868.

The dough may contain only one biodegradable polymer, or alternatively the dough may contain more than one biodegradable polymer. The biodegradable polymer may be a biodegradable polyester, polysaccharide, synthetic or semi-synthetic fiber, and/or combinations thereof. Examples of biodegradable polyesters may include polylactic acid, polybutylene adipate terephthalate, polyhydroxyalkanoates, polycaprolactone, polybutylene succinate, polyethylene succinate, and/or combinations thereof. Examples of polysaccharides may include cellulose, carrageenan, natural starches formed from corn, wheat, potato, rice, cassava, tapioca, arrowroot, and/or combinations thereof. In embodiments, the biodegradable polymer may be a thermoplastic starch. An example of a semi-synthetic fiber is viscose.

The dough is formed by mixing the slurry and the biodegradable polymer(s). In embodiments, the dough is formed by combining the slurry and the biodegradable polymer in an industrial mixer such as a kneader and mixing. Mixing in a kneader achieves excellent dispersion of the slurry in the biodegradable polymer because kneaders are particularly suited for mixing substances with high viscosity.

Mixing the biodegradable polymer and the slurry prior to extrusion enables a maximized loading and dispersion of heterogeneous additive throughout the polymer to be achieved. Mixing the slurry and the biodegradable polymer prior to extrusion ensures that the material is well mixed and mitigates any mixing issues that may occur during or after the extrusion process. Further, mixing the slurry and the biodegradable polymer prior to extrusion allows the plasticizer to affect the flow properties of the resulting dough, as described below.

In embodiments, the dough is free of unmixed bulk regions, as determined by visual inspection of the dough without magnification, i.e. the dough is visually uniform. As used herein, an “unmixed bulk region” refers to a region of the dough which is visually distinguishable from the rest of the dough and which is rough to the touch. The visual observation may be conducted on the dough itself, or alternatively, the dough may be extruded and then formed into a blown film, cast film, compression pressed film, or 2-roll mill film, and the film may be viewed against a light source to observe any unmixed bulk regions. The absence of unmixed bulk regions in the dough indicates that the biodegradable polymer and the heterogeneous additive are well mixed, making it less likely that there are regions of excessive or disproportionate concentrations of heterogeneous additive. Thus, absence of unmixed bulk regions indicates a higher uniformity of dispersion of the heterogeneous additive in the dough, which will lead to a higher uniformity of dispersion of the heterogeneous additive in the extrudate and in the formed polymeric film. The maximized uniformity of dispersion also allows for a higher loading of the heterogeneous additive.

In embodiments, the dough is capable of being formed into a sheet having a thickness of less than about 2.5 millimeters, alternatively less than about 2.0 millimeters, alternatively less than about 1.5 millimeters, alternatively from about 1.2 millimeters to about 1.5 millimeters, without disintegrating or falling apart. The dough in accordance with the methods provided herein is capable of being formed with the recited thicknesses, whereas existing polymeric doughs may have greater thicknesses because existing doughs may fall apart when smaller thicknesses are attempted. The capability to be formed into a thinner sheet without breaking means the dough in accordance with the methods provided herein has maximized malleability. Maximized strength and malleability of the dough leads to maximized strength and malleability of the resulting polymeric film.

In embodiments, sheets of the dough having a thickness of 2.5 mm have a constancy of elongation at break represented by a change of plus or minus no more than about 10%, alternatively from about 5% to about 10%, alternatively no more than about 5%, alternatively from about 1% to about 5%, alternatively no more than about 1%, as measured in accordance with ASTM D638 when at least 5 samples are tested. As used herein, “elongation at break” is defined as the change in length (the difference between the final length after testing and the initial length before testing) expressed as a percentage of the initial length. The elongation at break value represents the stretchability of the dough. As used herein, “stretchability” refers to the capability of the polymeric film to resist changes of shape without crack formation (i.e. the amount of deformation the film can withstand before it breaks). The recited values of constancy of elongation at break may represent a higher constancy than is characteristic of doughs formed in existing processes for forming biodegradable polymeric films. A maximized constancy of elongation at break represents a maximized uniformity of dispersion of the heterogeneous additive and the plasticizer throughout the film.

After the dough is formed, the dough is gel extruded to form an extrudate. In embodiments, the gel extrusion process may use a single-screw extruder, or alternatively a twin screw extruder. As used herein, “gel extrusion” refers to an extrusion process in which a material is forced through a nozzle or die under controlled conditions to extrude a continuous profile of the desired shape, and wherein the material is in the form of a gel during the extrusion. As used herein, “gel” refers to a viscoelastic multicomponent system formed by a structure-forming component and an absorbed liquid. A gel exhibits both viscous and elastic characteristics when undergoing deformation. This means that a gel has flow properties characteristic of fluids, while having elastic properties making it incapable of irreversible deformations. As used herein, a “gel” has a melt flow index (MFI) of at least about 5 g/10 min, alternatively from about 5 g/10 min to about 12 g/10 min, alternatively at least 12 g/10 min, as measured at a temperature of the dough of 190° C. with a load of 2.16 kg. Further, as used herein, the term “gelation” refers to the formation of a gel from a polymeric material. In the methods provided herein, the presence of the plasticizer in the dough renders the dough a gel before and/or during extrusion.

In a gel extrusion process, the material being extruded can be pushed through the extruder without heating the material above its melting point due to the unique flow properties of a gel. This allows for extrusion of biodegradable polymers which may be less heat resistant than non-biodegradable polymers traditionally used in polymeric films and that may break down under the heat of a traditional hot melt extrusion process. In the methods provided herein, the presence of the plasticizer affects the flow properties of the polymer dough, allowing the dough to be gel extruded. Specifically, the plasticizer increases the melt flow index of the polymer material, resulting in a dough with the recited flow properties, including the recited MFI.

Formation of the dough comprising the biodegradable polymer, the plasticizer, and the heterogeneous additive prior to extrusion allows for maximized dispersion of the additive in the polymer, which is generally difficult to achieve in a gel extrusion process. For example, if a heterogeneous additive with a relatively low bulk density or a relatively high aspect ratio is being used, it may be challenging to mix the additive in particulate form with the polymer due to relatively low temperatures that are utilized in gel extrusion.

In embodiments, the dough is gel extruded to form the extrudate in the form of the biodegradable polymeric film (i.e. the extrudate is the formed film). In other embodiments, the dough is gel extruded to form the extrudate in a shape other than a film, such as pellets or granules. The extrudate is then formed into the biodegradable polymeric film, for example by blowing, casting, thermoforming, compression pressing, or milling.

In embodiments, the extrudate is blended with an additional biodegradable polymer before the biodegradable polymeric film is formed. The additional biodegradable polymer may be the same as the biodegradable polymer present in the extrudate, or alternatively, the additional biodegradable polymer may be different from the biodegradable polymer present in the extrudate. In embodiments, an additional heterogeneous additive is added to the extrudate before the extrudate is formed into the polymeric film. The additional heterogeneous additive may be the same as the heterogeneous additive present in the extrudate, or alternatively, the additional heterogeneous additive may be different from the heterogeneous additive present in the extrudate.

In embodiments, the biodegradable polymeric film formed through the methods provided herein has a thickness of from about 1 micrometer to about 1000 micrometers, alternatively from about 20 micrometers to about 1000 micrometers, alternatively from about 20 micrometers to about 500 micrometers.

In embodiments, the biodegradable polymeric film formed through the methods provided herein has a water vapor transmission rate (WVTR) of less than about 1000 grams per square meter per day, alternatively from about 100 grams per square meter per day to about 1000 grams per square meter per day, alternatively less than about 500 grams per square meter per day, alternatively from about 100 grams per square meter per day to about 500 grams per square meter per day, alternatively from about 1 gram per square meter per day to about 100 grams per square meter per day, alternatively from about 20 grams per square meter per day to about 80 grams per square meter per day, as measured in accordance with ASTM E96 at a temperature of 22° C. and a relative humidity of 50%, for films having thicknesses as described above. The recited WVTR values may be lower than what would be typical of an existing biodegradable polymeric film, providing the advantage of lower permeability as compared to existing biodegradable polymeric films (which do not exhibit acceptable performance). However, the recited WVTR values are higher than what would generally be acceptable for use in existing polymeric films, which usually utilize materials with as low of a WVTR as possible (e.g. non-biodegradable polymers such as polyethylene or polypropylene). Because biodegradable polymers tend to have higher WVTR than non-biodegradable polymers, existing biodegradable polymeric films do not exhibit excellent resistance to ingress of water, oxygen, and other materials. However, in embodiments of the polymeric films as provided herein, a biodegradable polymeric film with acceptable performance can be realized. Specifically, in embodiments in which the plasticizer exhibits antioxidant properties and the heterogeneous additive is a VCI additive, the corrosion resistance properties are sufficient to protect a metal part that is packaged in the polymeric film, despite a relatively high WVTR and thus a relatively high amount of water ingress. Further, in this embodiment, the higher WVTR value actually increases VCI activity, because the VCI additive polarizes in the presence of water and then adsorbs onto the surface of the metal object, passivating the surface of the metal object to protect it against corrosion.

In one particular embodiment, the biodegradable polymeric films provided herein comprise fumed silica as the heterogeneous additive, glycerol as the plasticizer, and a VCI additive as the additional heterogeneous additive. In embodiments, the biodegradable polymeric films also comprise natural starch as the biodegradable polymer.

In embodiments, the biodegradable polymeric films provided herein are incorporated into composite articles. The composite articles provided herein comprise the biodegradable polymeric films described above in combination with an additional layer having a composition different from that of the biodegradable polymeric film. The composite article may contain only one additional layer, or the composite article may contain more than one additional layer. The additional layer may be a polymeric film, or the additional layer may be something other than a polymeric film. In embodiments, the polymeric film may be laminated to the additional layer, and the additional layer may be a molded, woven, or non-woven film or sheet. If the additional layer is a polymeric film, the additional layer may contain biodegradable polymers, or the additional layer may not contain biodegradable polymers. The additional layer may be, for example, a hydrophobic layer, a moldable layer, or combinations thereof. In embodiments, the additional layer may be a volatile corrosion inhibitor layer comprising a VCI additive. In embodiments, the additional layer may be an antioxidant layer having antioxidant properties. The composite article may be, for example, a multi-layer film, a blister pack, bubble wrap, a laminated paper, a coated surface, and/or combinations thereof.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

### EXAMPLES

### Example 1

Two batches of starch dough were formed through two different processes. Batch 1 was a comparative example formed through a method not in accordance with this disclosure. For Batch 1, 500 grams of precipitated silica (SiO₂), 600 grams of glycerol, and 900 grams of natural starch powder were combined and mixed in a kneader for 80 minutes to form a thermoplastic starch loaded with silica and glycerol. Batch 2 was formed through a method in accordance with this disclosure. For Batch 2, 500 grams of precipitated silica and 500 grams of glycerol were combined and subjected to a high shear mixing process in a Jogindra Engineering JJH-010 mixer with no added heat for 20 minutes to form a slurry. The slurry was then combined with 900 grams of natural starch powder and 100 grams of organic oil plasticizer in a kneader, and mixed with no added heat for 60 minutes to form a thermoplastic starch loaded with silica and glycerol. Then, both batches of starch dough were fed to a Deepak Poly Plast 2-roll mill at a temperature of 100° C. and a roll speed of 3 m/min to form sheets. The results are shown below in Table 1.

TABLE 1
Properties of Dough from Disclosed Process vs. Existing Process

| | | Thickness of | |
|---|---|---|---|
| | Presence of Unmixed | Thinnest Roll | Elongation at |
| Batch | Bulk Regions | Mill Sheet | Break of Sheet |
| Batch 1 | Yes | 2.5 mm | 37.2 +/− 6.2% |
| (Comp. Ex.) | | | |
| Batch 2 | No | 1.2 mm | 73.9 +/− 15.4% |

The presence of unmixed bulk regions in the dough was determined by visually observing the dough. Any regions that appeared white and clumpy were designated unmixed bulk regions. The thickness of the thinnest roll mill sheet was measured by creating a sheet as described above and then measuring the thickness. The elongation at break was measured by measuring the length of each sheet, stretching the sheet laterally until the sheet broke, measuring the length of the sheet again, and then calculating the change in length and expressing it as a percentage of the initial length.

The results of Example 1 demonstrate that material formed through a process involving mixing silica (a heterogeneous additive) with glycerol (a plasticizer) to form a slurry prior to combination with natural starch (a biodegradable polymer) (Batch 2) results in a dough with fewer unmixed bulk regions than material formed through a process involving mixing of additives in particulate form with polymers in the same step (Batch 1). The results also show that the material in Batch 2 was stronger (had a higher elongation at break) and more malleable (was able to be formed into thinner sheets) than the material in Batch 1.

### Example 2

A starch dough was formed using the procedure described above for Example 1. Then, in a twin-screw extruder (Useon 20, Nanjing Extrusion) with 15% kneading block elements, L/D of 48/1, and screw diameter of 22 mm, the dough was compounded with polybutylene adipate terephthalate (PBAT) at a weight ratio of 10/90. A mixture of amine-based vapor corrosion inhibitor additive was also added in an amount of 3-5%, based on the total weight of the compounded material. The strand die was maintained at a temperature from 145° C. to 155° C. and the compounded material was pelletized under water cooling. Vacuum pull was maintained to reduce the amount of water absorbed into the mixture. The resultant pellets were oven dried at a temperature of 65° C. for 4 hours, until the percentage of water absorbed was less than 0.5%.

Then, the compounded material was run on a single screw extruder (Omega 25, Steer Extruders) with a blown film die. Films were extruded at a width of about 100 mm and a thickness of 75 microns. The elongation at break of the films was measured as described above for Example 1, and the elongation at break of each film was greater than 100%. The tensile strength of each film was measured in accordance with ASTM D638, and the tensile strength of each film was found to be about 30 MPa.

### Example 3

Four samples of ferrous washers were prepared. In Sample 1, the ferrous washer had no packaging. Sample 1 is a comparative example showing the results of exposing the washer directly to the testing with no protective packaging. In Sample 2, the ferrous washer was packaged inside an existing biodegradable polymer film bag. In Sample 3, the ferrous washer was packaged inside an existing VCI polymer film bag. The bags used in Samples 2-3 are comparative examples formed through methods not in accordance with this disclosure. In Sample 4, the ferrous washer was packaged inside a biodegradable polymer film bag with a VCI additive, formed through a method in accordance with this disclosure. Specifically, the bag used in Sample 4 was produced by forming a dough according to the procedure described for the dough in Batch 2 in Example 1. The dough was then blended with a VCI additive and gel extruded to form a film as described above for Example 2, and the film was formed into the bag used in Sample 4.

A salt spray test was conducted on each sample in accordance with ASTM standard B 117-19. In this test, a salt solution was atomized into a sealed Q-FOG cyclic corrosion testing chamber, creating a continuous fog of saltwater mist. The salt solution used to provide the salt fog mist was 5 wt % sodium chloride (NaCl) in aqueous solution with the pH adjusted to about 7.0. The test samples were then placed in the chamber and exposed to the saltwater mist for 500 hours.

The effectiveness of each bag was evaluated based on a visual inspection of the ferrous washer and a qualitative tactile inspection of the bag. For Sample 1, the ferrous washer showed complete rusting and pitting, even when observed after 24 hours in the testing chamber. For Sample 2, after 500 hours, water ingress was observed. The sample bag displayed low tear strength upon handling. The washer displayed low/medium scale rust with no pitting. For Sample 3, after 500 hours, no water ingress was observed, and the sample bag displayed good strength, similar to the strength of the bag before the salt spray test was conducted. For Sample 4, after 500 hours, no water ingress was observed, and the sample bag displayed good strength, similar to the strength of the bag before the salt spray test was conducted.

The results of Example 3 show that, unlike any of the other samples, a biodegradable polymeric film produced through a method in accordance with this disclosure and having VCI additives in the film (Sample 4) exhibits both excellent strength properties and excellent corrosion resistance. Sample 4 exhibited improved strength properties as compared to an existing biodegradable polymeric film (Sample 2). Further, Sample 4 showed equivalent corrosion resistance as an existing VCI polymeric film (Sample 3), while having the further quality of being biodegradable.

What is claimed is:

1. A method of producing a biodegradable polymeric film, the method comprising the steps of:
mixing a heterogeneous additive and a plasticizer to form a slurry;
mixing the slurry and a biodegradable polymer to form a dough; and
gel extruding the dough to form an extrudate.

2. The method of claim 1, wherein the heterogeneous additive and the plasticizer are mixed in a high shear mixer to form the slurry.

3. The method of claim 1, wherein the dough is extruded to form the biodegradable polymeric film.

4. The method of claim 1, further comprising forming the extrudate into the biodegradable polymeric film.

5. The method of claim 4, further comprising blending the dough with an additional biodegradable polymer after the gel extruding step and before the forming step.

6. The method of claim 4, further comprising blending the dough with an additional heterogeneous additive after the gel extruding step and before the forming step.

7. The method of claim 1, wherein the slurry and a compostable polymer are mixed to form the dough.

8. The method of claim 1, wherein the slurry and the biodegradable polymer selected from natural starch, cellulose, carrageenan, viscose, polylactic acid, polybutylene adipate terephthalate, polyhydroxyalkanoates, polycaprolactone, polybutylene succinate, or combinations thereof, are mixed to form the dough.

9. The method of claim 1, wherein the heterogeneous additive and the plasticizer which exhibits antioxidant properties are mixed to form the slurry.

10. The method of claim 1, wherein the heterogeneous additive having a bulk density of less than about 300 kg/m³ and the plasticizer are mixed to form the slurry.

11. The method of claim 1, wherein the heterogeneous additive, having at least about 50% of the particles of the heterogeneous additive with an aspect ratio of at least 50, and the plasticizer are mixed to form the slurry.

12. The method of claim 1, wherein the slurry and the biodegradable polymer are mixed to form a dough having an amount of the heterogeneous additive of at least about 10 wt %, based on a total weight of the dough.

13. The method of claim 1, wherein a volatile corrosion inhibitor additive and the plasticizer are mixed to form the slurry.

14. The method of claim 1, wherein the plasticizer and the heterogeneous additive selected from fumed silica, precipitated silica, titanium dioxide, talc, calcium carbonate, zinc oxide, graphene, activated carbon, diatomaceous earth, glass fibers, clay, and/or combinations thereof, are mixed to form the slurry.

15. A biodegradable polymeric film formed by a process comprising:
mixing a heterogeneous additive and a plasticizer to form a slurry;
mixing the slurry and a biodegradable polymer to form a dough; and
gel extruding the dough to form an extrudate.

16. The biodegradable polymeric film of claim 15, wherein the biodegradable polymeric film has a water vapor transmission rate of less than about 500 grams per square meter per day, as measured in accordance with ASTM E96 at a temperature of 22° C. and a relative humidity of 50%, and a film thickness of from about 1 micrometer to about 1000 micrometers.

17. A composite article comprising:
the biodegradable polymeric film of claim 15; and
an additional layer having a composition different from that of the biodegradable polymeric film.
